(19) United States
(12) Patent Application Publication
(10) Pub. No.: US 2010/0065533 A1
(43) Pub. Date: Mar. 18, 2010

(54) Adaptive Resistance Weld Control

(75) Inventors: Paul Robert Buda, Raleigh, NC (US); Timothy Eugene Miller, Clayton, NC (US); Robert Michael Slazinski, Lake Orion, MI (US)

Correspondence Address: SCHNEIDER ELECTRIC / SQUARE D COMPANY;LEGAL DEPT. - I.P. GROUP (B&W), 1415 S. ROSELLE ROAD, PALATINE, IL, 60067, US

(73) Assignee: SQUARE D COMPANY, Palatine, IL (US)

(21) Appl. No.: 12/334,918

(22) Filed: Dec. 15, 2008

Related U.S. Application Data
(60) Provisional application No. 61/098,150, filed on Sep. 18, 2008.

(51) Int. Cl. B23K 11/24

(52) U.S. Cl. 219/110

(57) ABSTRACT

A resistance weld control employing a model-based run-to-run estimate of load impedance, giving the weld control system the ability to maintain and predict the expected impedance of a successfully completed resistance spot weld, and to detect when the load impedance observed by the resistance weld control is within a target neighborhood of that impedance predicted by the model-based run-to-run estimate of load impedance. A target weld current and a range of weld times may be specified, such that the actual weld time employed in making the resistance spot weld is responsive to the time required to complete the contact preparation phase. Further, a fixed weld time and a range of target weld currents may be specified to make a resistance spot weld, such that the actual target weld current employed is responsive to the time required to complete the contact preparation phase of the weld.

### BACKGROUND

A resistance weld is created by passing a high current at a low voltage for a period time through two or more sheets of metal, often referred to as a “weld stack-up.” Because the impedance of a given weld stack-up is not fully predictable, the current may be higher or lower than expected for a given voltage. This variation in impedance may be greatly affected by part fit-up and surface preparation variability.

If the current is too high or too low, the weld may be too weak. Generally, resistance welds today are created using more current and/or weld time than is predicted for an optimal weld, to ensure that most, if not all welds will at least have acceptable strength. The result is that many, if not most, welds are provided with more heat than required for optimal strength and the best fitting, cleanest components generally receive significantly more heat than is desirable, resulting in wasted energy and reduced weld strength.

This is compounded by the present trend in automobile production to employ thinner metals having higher strength to improve the crash worthiness of a vehicle while simultaneously making the automobile body lighter, thereby improving fuel economy. Not surprisingly, these thinner metals are more sensitive to over-heating by the resistance weld process. Perhaps not as intuitively obvious is that the stronger alloys employed by design do not deform as readily and can cause the time spent in contact preparation phase (i.e., the time it takes to warm the weld stack-up to a sufficient temperature to begin the actual weld) to increase over a softer, more malleable metal. Simply increasing weld time or weld current is rapidly becoming an unacceptable approach to compensate for variable contact preparation phase time.

### SUMMARY

A weld control system that can account for the variability in initial fit-up and surface preparation without needing to overheat most parts to achieve statistically good weld quality is highly desirable. This can be substantially accomplished by modifying either the target weld current or weld time, responsive to the detection of completion of the contact preparation phase of the weld as described above.

A resistance weld control is therefore described that employs a model-based run-to-run estimate of load impedance of a weld stack-up, giving the weld control system the ability to maintain and predict the expected impedance of a successfully completed resistance spot weld. The weld control may further have the ability to detect when the load impedance observed by the resistance weld control is within a target neighborhood of that impedance predicted by the model-based run-to-run estimate of the load impedance.

By using such a weld control, the user may be able to specify a target weld current and a range of weld times, such that the actual weld time employed in making the resistance spot weld is responsive to the time required to complete the contact preparation phase. The user may additionally or alternatively be able to specify a fixed weld time and a range of target weld currents to make a resistance spot weld, such that the actual target weld current employed is responsive to the time required to complete the contact preparation phase of the weld.

Thus, some aspects as described herein are directed to a method for controlling a resistance weld, comprising driving a current through a weld stack-up, determining whether an end of a contact preparation phase has occurred, and stopping the driven current at a specific time that is based on when the end of the contact preparation phase is determined to have occurred.

Further aspects are directed to a method for controlling a resistance weld, comprising driving a current through a weld stack-up, a magnitude of the driven current increasing over time, determining whether an end of a contact preparation phase has occurred and holding the magnitude of the driven current at a fixed level for a time period responsive to determining that the end of the contact preparation phase has occurred.

Still further aspects are directed to an apparatus for controlling a resistance weld of a weld stack-up, the apparatus comprising a transformer having first and second windings, and a weld controller having an output coupled to the first windings. The weld controller is configured to drive a current through the first winding, determine whether an end of a contact preparation phase of the weld stack-up has occurred, and stop the driven current at a specific time that is based on the determined occurrence of the end of the contact preparation phase.

Still further aspects are directed to an apparatus for controlling a resistance weld of a weld stack-up, the apparatus comprising a transformer having first and second windings, and a weld controller having an output coupled to the first windings, wherein the weld controller is configured to drive a current through the first windings, a magnitude of the driven current increasing over time, determine whether an end of a contact preparation phase has occurred, and responsive to determining that the end of the contact preparation phase has occurred, hold the magnitude of the driven current at a fixed level.

Still even further aspects are directed to a method for controlling a resistance weld, comprising driving a current through a weld stack-up, determining a current flowing through the weld stack-up, determining whether the determined current is within a threshold amount of an expected current, and performing one of the following: (1) responsive to an outcome of the comparing, stopping the driven current, and (2) responsive to the outcome of the comparing, holding a magnitude of the driven current at a fixed level.

Yet further aspects are directed to a method for controlling a resistance weld, comprising driving a current through a weld stack-up, determining an impedance of the weld stack-up, determining whether the determined impedance is within a threshold amount of an expected impedance, and performing one of the following: (1) responsive to an outcome of the comparing, stopping the driven current, and (2) responsive to the outcome of the comparing, holding a magnitude of the driven current at a fixed level.

These and other aspects of the disclosure will be apparent upon consideration of the following detailed description.

### BRIEF DESCRIPTION OF THE DRAWINGS

A more complete understanding of the present disclosure and the potential advantages of various aspects described herein may be acquired by referring to the following description in consideration of the accompanying drawings, in which like reference numbers indicate like features, and wherein:

FIGS. 1 and 2 are side views of an illustrative weld stack-up and weld gun during various stages of the welding process.

FIG. 3 is a schematic of an illustrative single-phase alternating-current (AC) phase-controlled weld system.

FIG. 4 is a schematic of an illustrative medium frequency direct current (MFDC) weld system.

FIG. 5 is an example of a constant current weld program.

FIG. 6 is a graph of a constant current weld profile.

FIG. 7 is a graph of a sloped current weld profile.

FIG. 8 is a graph of weld strength versus weld time.

FIG. 9 is a graph of weld strength versus weld current.

FIG. 10 is a graph of optimal weld current versus weld time in units of AC power line cycles.

FIG. 11 is a detailed side view of a weld stack-up with weld caps.

FIG. 12 is a graph of instantaneous weld stack-up contact resistance versus time.

FIG. 13 is a flow chart of illustrative steps that may be taken to determine whether a contact preparation time has ended.

FIG. 14 contrast a fixed time weld program with a variable time weld program.

FIG. 15 contrasts a fixed time weld current profile with a variable time current profile.

FIG. 16 is a graph of a family of current weld profile curves that may be generated.

FIG. 17 shows an example of a variable maximum current weld program.

FIG. 18 is a graph of a family of current weld profile curves that may occur as a result of the program of FIG. 17.

### DETAILED DESCRIPTION

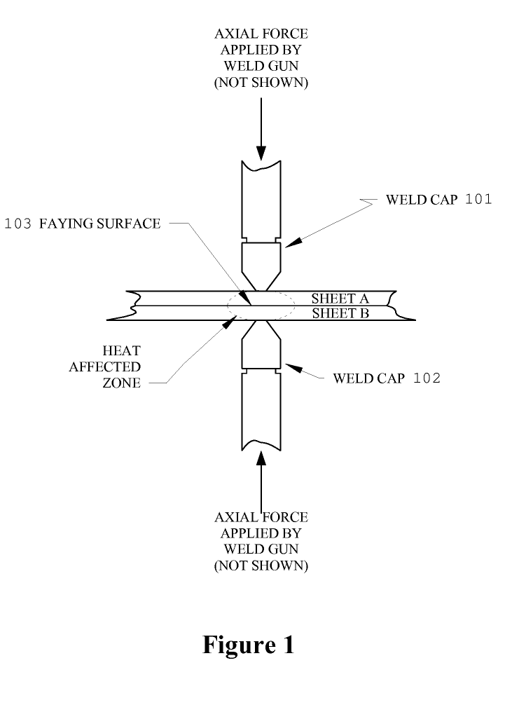

A resistance weld is created by passing a high current at a low voltage through two or more sheets of metal via weld caps generally made of a copper alloy attached to a mechanism which also forces the weld stack-up together as current is passed. FIG. 1 shows an example configuration of two pieces of sheet metal to be joined prior to application of weld current, labeled SHEET A and SHEET B. During the entire process of making a resistance weld, these two sheets are pressed together under axial pressure, usually applied by a pair of weld caps 101, 102 constructed, for example, of a copper alloy.

The axial pressure is applied by affixing the weld caps 101, 102 to a device commonly called a weld gun. The area 103 where the two pieces of sheet metal contact each other directly between the weld caps is commonly called the “faying surface”, a term meaning the surface at which two materials are to be joined. The resistance weld community often refers to a concept called the “heat affected zone”, which is not sharply defined but intends to communicate a small neighborhood in the vicinity of where the weld is intended to be made and over which the heat generated can generate stresses which can alter the shape or metallurgical characteristics of the metal. In FIG. 1, the heat affected zone is the region directly between the caps 101, 102 and at the faying surfaces 103. One of the advantages of resistance spot welding over other technologies such as arc welding is that the heat affected zone is very small. This enables a strong weld to be made with minimal distortion of the surrounding metal.

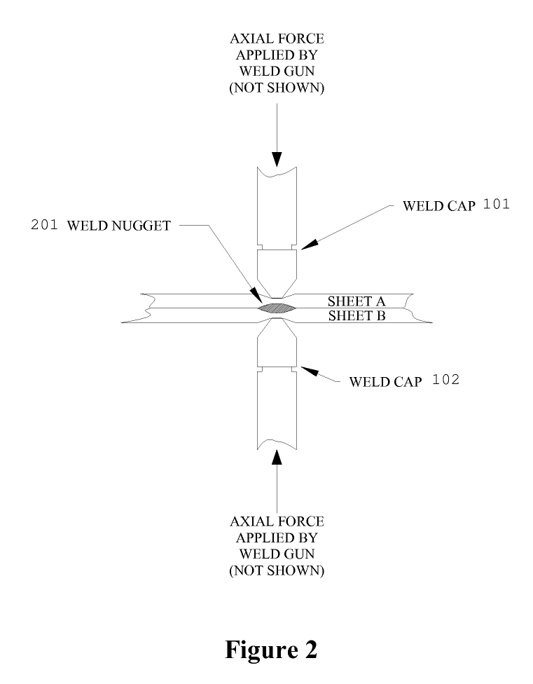

To create a resistance spot weld, a voltage is applied across the weld caps 101, 102 under the condition outlined above which causes current to flow through the metal. Current crosses the boundary between sheets A and B primarily in the area directly between the weld caps 101, 102 since that is where the best contact between the sheets should be achieved. The resulting condition is shown by way of example in FIG. 2. As the current passes through the metal, it heats up, eventually reaching the fusion temperature of the metal, which melts and creates a weld nugget 201, a point at which the molten metal intermingles and the two pieces of metal fuse together. Normally, significant melting does not occur at the interfaces between the weld caps 101, 102 and the metal relative to that at the faying surfaces 103, but in the process of creating the weld, the metal can anneal sufficiently that the weld caps 101, 102 leave an indentation on the surfaces of the metal to be joined as shown. If the voltage is removed from the weld caps 101, 102 after fusion takes place while the weld gun continues to apply force against the sheets under a quiescent condition while the molten metal cools, the newly formed joint between the two sheets A and B can be very strong under the proper conditions.

A typical voltage impressed upon the output of a weld gun to create a strong resistance spot weld in thin steel of the type normally employed in construction of an automobile body is on the order of 5 Volts (V), and the resulting weld current is on the order of 10,000 Amperes (A), with typical weld times on the order of 200 milliseconds (mS). Typical nominal bus voltages of low voltage power distribution found in an automobile body shop are 400 Volts in Europe and 480 Volts in the United States, and the individual branch feeder to a resistance welder is generally protected against thermal overload with fuses or circuit breakers having long term limiting values on the order of 100 to 400 Amperes.

To achieve conversion between high voltage and low current of the distribution system to the low voltage and high current required to make a resistance spot weld, the weld caps 101, 102 are coupled to the secondary of a step down weld transformer, the primary of which is in turn coupled to the high voltage power system through a control system commonly called a resistance weld controller, which also regulates the voltage or current to achieve an objective to be described subsequently. There are two main types of resistance weld power conversion systems generally employed in an automobile body shop, namely an alternating current (AC) phase controlled system and an MFDC (for Medium Frequency Direct Current) system.

The physically simpler of the two in terms of component count is the single-phase AC phase controlled weld system utilizing two thyristors wired in parallel and “back to back” so that under normal conditions the thyristors block the flow of current. FIG. 3 shows a simplified example of such a control 300, in which thyristors 301 and 302 are wired in parallel and back to back and connected to one winding of a transformer 304. A thyristor is a three terminal semiconductor device comprising an anode terminal, a cathode terminal and a gate terminal. When a negative voltage is applied between the anode and cathode, the thyristor blocks the flow of current. When a positive voltage is applied between the anode and cathode, the thyristor blocks the flow of current through it until it receives a firing pulse of current into the gate input of the device, returning to its source via the cathode. Once a pulse of current is forced into the thyristor gate, the device allows current to flow between the anode and cathode of the device while the device continues to be forward biased. When the device is no longer forward biased, it recovers and blocks current again until it is once again forward biased and triggered via a gate pulse. Setting two of these devices in parallel and in opposite directions (cathode of one device connected to anode of the other and vice versa) allows the weld control to control current in both directions by judicious application of gate pulses to the correct thyristor 301, 302 and at the correct time by a weld timer 303.

In a single-phase AC phase controlled resistance welder, the weld timer 303 is synchronized to the input line voltage Vs. The system is referred to as “phase controlled” because the timing of the gate pulses is usually referenced to the timing of the input line voltage Vs, creating a phase delay between the zero-crossings of the voltage supplied by the power mains and application of that voltage to the weld transformer.

Because a thyristor, once gated, conducts until reverse biased, the weld timer 303 generates gating signals to the thyristors 301, 302 as needed to control voltage or current at a maximum rate of one gating signal per half cycle of the distribution system line voltage. Weld Timer 303 may control thyristors 301, 302 based on voltage and/or current measurements that are taken, such as by current measurer 305. The rate at which corrections can be made to the firing points to achieve an objective time-based profile of voltage, current or power is further limited to once per line cycle if the magnetic flux in the transformer 304 is to be simultaneously managed over a line cycle to prevent transformer saturation. Thus, in a 50 Hertz (Hz) system in which current is intended to be generated for 10 line cycles (corresponding to 200 mS of “weld time”), the weld control can make a total of 10 independent modifications to the firing points of the thyristors 301, 302 to achieve a desired profile. This serves as a limitation to an AC phase controlled welder, but AC phase controlled welders have been successfully employed for many years, due to the low cost and simplicity of design.

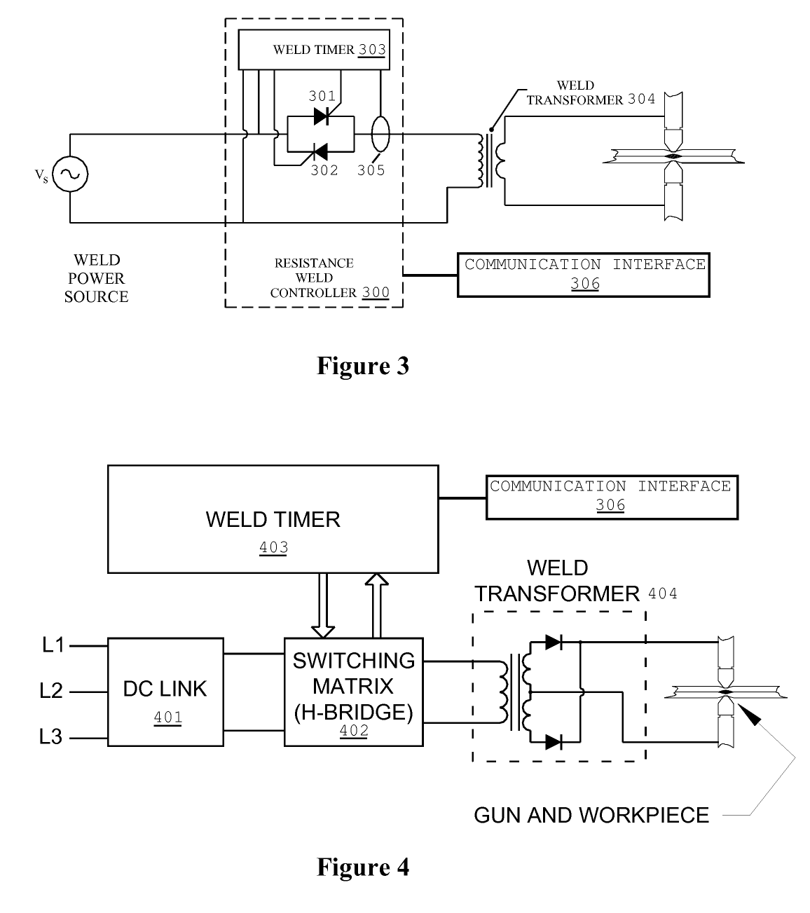

A second method to control the voltage applied to the weld caps 101, 102 is commonly called a medium frequency DC or MFDC weld system. FIG. 4 shows an illustrative topology of such a system. In such a system, power from the power distribution system, usually in the form of three phase AC power is first fed to a DC link 401, comprising a full wave rectifier or thyristor assembly, a link inductor to reduce harmonic distortion on the power distribution system, and capacitance, usually in the form of a bank of large electrolytic capacitors. The object of the DC link 401 in this example is to provide a relatively stiff source of DC voltage to a matrix of switching devices commonly known as an “H-Bridge” 402. An H-Bridge 402 in a resistance welding device typically comprises four switching devices which are under control of a weld timer 403. The most common switching devices presently employed are insulated gate bipolar transistors, or IGBT's.

In operation, the DC voltage of the DC link is switched to a weld transformer 404 in one polarity for a short period then removed. By closing other switches in the H-Block, DC voltage can then be applied to the transformer 404 in the opposite or “inverted” polarity. In this system, the weld timer 403 controls the voltage applied to the transformer 404, as well as the frequency of the voltage applied by controlling the individual switches that make up the H-bridge 402. The method enables the frequency at which the DC voltage is switched to the transformer 404 to be significantly higher than the AC phase controlled method described above which is limited to that of the input line frequency. A typical switching frequency applied in production resistance welding is 1000 Hz. This higher switching frequency permits the use of physically smaller weld transformers, and allows a finer degree of control than can generally be obtained with the AC phase controlled process. The impedance presented by the inductance of the secondary circuit of the transformer 404 is sufficiently high at these frequencies that it generally limits the current that can be produced by the weld control to values less than required to make a weld. To counteract this limitation, the secondary output of the weld transformer 404 is full wave rectified as shown in FIG. 4. The following features will be described by way of example with reference to the AC phase controlled system of FIG. 3. However, it will be understood that these features may be embodied in other types of systems such as an MFDC system (e.g., as in FIG. 4).

Modern weld timers are sophisticated, programmable control devices, normally under microprocessor control. In one version of a weld timer a digital signal processor device is employed to monitor and control generation of voltage and current to achieve a user defined heat profile objective, while a separate microprocessor device provides the weld sequencing control. In a modern automobile body manufacturing facility, weld timers communicate via one or more communication networks to operator interface workstations, servers and sequencing devices such as robots and programmable logic controllers. Independent of which power conversion system is employed, one function of the weld timer shown in FIG. 3 and FIG. 4 is to develop a user specified “heat profile” to be applied to the metal to be welded. The timer does so by switching voltage to the primary windings of the associated weld transformer and monitoring the resulting current. It is the management of this heat profile that will be described herein. To facilitate control of the heat profile, the weld timer incorporates an estimator of secondary weld current, as well as an estimator of voltage applied. There are many ways to accomplish these estimates, including direct measurement of voltage and current in the secondary circuit of the weld transformer and measuring the primary current and voltage and using known or assumed characteristics of the weld transformer to estimate the secondary voltage and current from the primary measurements. Many modern systems incorporate both primary and secondary current estimation.

Modern resistance weld controls sometimes incorporate a programming language to permit the user of the equipment to construct an arbitrary target trajectory of current versus time, and resistance weld controls sometimes utilize operator interface software running in a personal computer or a dedicated operator interface device coupled to the weld timer via a communication interface to permit the programmer of the weld control to generate, view and edit weld programs. An example of such resistance weld controls are those manufactured by Schneider Electric. In these present generation weld controls, times are typically specified in line cycles rather than in other time units, such as milliseconds. This is done in the AC phase controlled resistance welder because the combination of the physics of thyristor operation and the need to maintain magnetic flux balance in the weld transformer core limits the time quanta to a power line cycle. This programming method is carried over to the MFDC resistance weld control as a matter of programming convenience. However, the time quanta for an MFDC resistance weld control is determined from the inverter switching frequency, allowing finer control than the AC phase controlled counterpart.

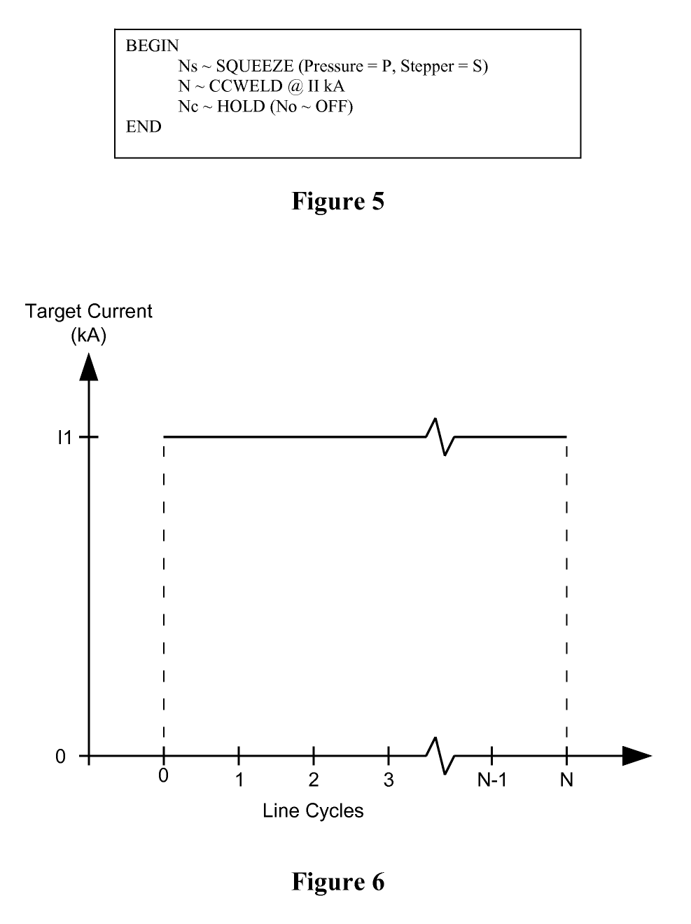

An example of a simple weld program that can be generated in a Schneider Electric resistance weld control is shown in FIG. 5. The weld program may be entered, for example, by the user via a user interface communicatively coupled to weld controller 300 via a communication interface 306. Communication interface 306 may include a weld sequence control interface and a weld process control interface. The weld sequence control interface is typically used for communication between an external device (e.g., an industrial robot) and the welder. For instance, the robot may inform the welder via the weld sequence control interface (and any intervening network) when to weld and what weld program to execute. In the reverse direction, the weld control may inform the robot that welding has begun, that welding has completed, and weld result declarations such as normal completion of the weld, or completion with detected and enumerated exceptions. The weld process control interface is typically used for communication between the weld control and devices that may include a local user interface, a workstation, a factory manufacturing system, and other computer systems with an interest in specifying, gathering, and processing weld information. The weld sequence control interface and the weld process control interface may or may not be physically separate, and may or may not share the same physical communication pathways, such as wires or another network, to destinations outside the welder.

The user interface may include, for instance, a keyboard, mouse, and/or other device that may be used by a human to input information. Alternatively, the weld program may be generated off-line in a computer and provided to weld controller 300 via a computer-readable medium storing the weld program, such as a hard drive, floppy disc, optical compact disc, etc., or via communication interface 306. Libraries of various weld programs often exist and are maintained by users of weld controls for the different weld stack-ups anticipated in a given environment. The weld program may be made up of one or more computer-executable instructions, such that when the instructions are executed by weld controller 300, the weld controller 300 performs the functions defined by those instructions. Thus, weld controller 300 may include a processor for executing these instructions. The processor may be in the form of, for example, a central processing unit (CPU) embedded in weld controller 300, dedicated control circuitry, and/or a computer physically part of or physically separate from weld controller 300. In addition, weld controller 300 may include or otherwise have communicative access to a computer-readable medium (e.g., a memory, hard drive, etc.) for temporarily or permanently storing the computer-executable instructions and/or data, both of which may be read to and/or written from the computer-readable medium as needed. User interface 306 may include not only an information input device, but also an information output device such as a display or other human-compatible indicator.

The example program shown in FIG. 5 is interpreted as follows: The construct “BEGIN” is inserted by the weld control automatically to delineate the beginning of a weld program. The construct:

Ns˜SQUEEZE (Pressure=P, Stepper=S)

is a construct that causes a weld gun to generate a force on the weld caps and hold that force for Ns line cycles, with the intent of deforming the work piece to create proper contact with the weld caps. A modern resistance weld control contains provisions for a stepper program which permits creation of a relation between the number of times a weld gun has been closed and re-opened since a reference count and an additive or multiplicative “boost” of current and/or pressure to the subsequent weld constructs to account for the fact that the typical copper alloy weld caps employed “flatten” as they are used. In the instruction above, the parameter “S” points to one of these relations pre-defined elsewhere as part of the setup of the resistance weld control.

The construct

N→CCWELD @ II kA

is an instruction that directs the weld control to generate the current in the work piece that causes heat to be generated. This instruction will be addressed in more detail subsequently.

The construct

Nc˜HOLD (No˜OFF)

Causes the weld control to continue to generate pressure for Nc line cycles after current has ceased to pass, allowing the molten metal generated by the heat applied by the CCWELD instruction to solidify under quiescent conditions. The subscript “c” in N_{c} is intended to describe the quiescent cooling time of the weld. The parametric construct No˜OFF is used to facilitate sequencing between the weld timer and external equipment, such as a programmable logic control or industrial robot, to which the weld timer may be coupled via the weld sequence control interface. For instance, this structure causes the weld timer to signal external equipment coupled to the weld sequence control interface that the weld is complete after No line cycles.

The construct “END” is automatically inserted in the program by the weld control and signifies to the user the end of this program.

Modern resistance weld controls incorporate a feature commonly referred to as “constant current” welding in which a target profile of current vs. time is specified and the weld control modifies the voltage applied across the weld caps as necessary to achieve the target current vs. time profile. An assumption is that if everything is operating in a nominal manner, a repeatable current vs. time profile applied to a given geometry of resistance spot weld should result in an acceptable resistance spot weld every time, independent of the tooling used to deliver the current to the weld. One example of a weld programming construct historically employed in Schneider Electric resistance weld controls by which the user can specify a target trajectory of current vs. time is:

N˜CCWELD @ I1 kA

This construct is interpreted as follows: Weld for N power line cycles with a target current of I1 kA, modifying the applied voltage as the weld progresses to achieve and maintain the specified target current. FIG. 6 illustrates a target weld current that may result from this instruction.

Another example of a weld programming construct historically employed in Schneider Electric resistance weld controls by which the user can specify a target trajectory of current vs time is a so-called “slope” instruction which takes the form:

N˜CCSLOPE @ I1 kA to I2 kA

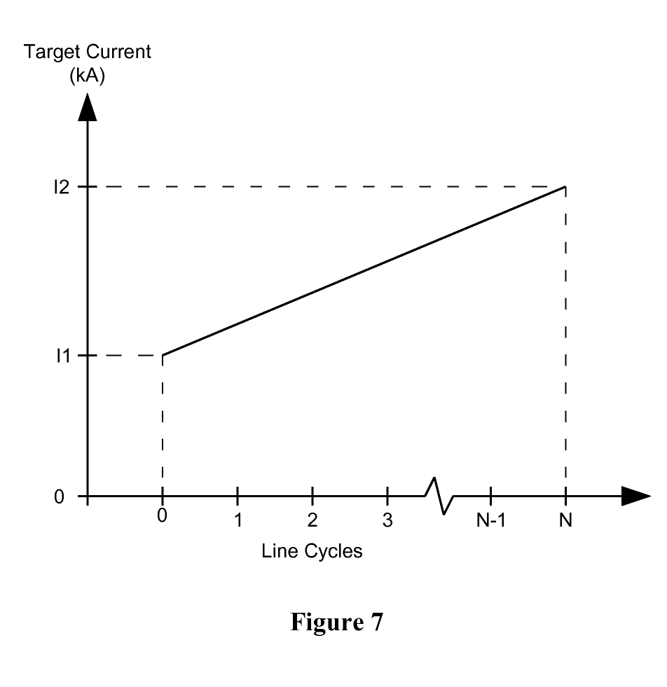

This instruction causes the weld control to generate a target current trajectory comprising a ramp over N power line cycles, beginning with I1 kA and ending with I2 kA. A typical trajectory generated by the weld control for the CCSLOPE instruction is shown in FIG. 7. As shown, I1 is less than I2, but I1 can be programmed greater than or equal to I2 as well.

Present Schneider Electric resistance weld controls also employ a mode of operation commonly referred to as % I welding. In % I welding, the weld control selects and applies a conduction time for the switching devices to apply a voltage to a weld transformer that should result in a programmed percentage of maximum available weld current, normalized to a programmable maximum allowable transformer voltage. Two programming constructs that permit the user to specify % I welds are:

N˜WELD @ P %

and

N˜SLOPE @ P1% to P2%

The trajectories generated by these weld constructs are similar to those of the CCWELD and CCSLOPE with target currents replaced by target percentages of available currents respectively. % I weld constructs are typically used in modern resistance welding primarily to allow the weld control to prepare the parts to be welded prior to applying a constant current weld to establish the appropriate metallurgy as will be discussed below.

### How Resistance Spot Welds are “Designed”

From a philosophical perspective, the requirements to produce a metallurgically sound resistance spot weld in a high volume environment such as construction of an automobile body can be viewed as comprising two main parts. First, one needs a resistance weld control system that can develop and deliver a defined, repeatable profile of current and weld cap force vs. time, henceforth called the “heat profile” to any reasonable arrangement of metal pieces to be welded, the so-called weld stack-up. The second requirement is specification of a heat profile that can be executed by the resistance weld control for the specific weld stack-up that generates a metallurgically sound weld. To understand potential advantages of the present invention in practical situations, it is instructive to turn attention to the actual development of the heat profile, usually determined empirically. An assumption, tacit or otherwise, in the initial phase of developing a heat profile to create a metallurgically sound weld is that the parts are free of surface contamination and fit together without gaps. To determine the appropriate heat profile in the laboratory, small, flat samples of the material to be joined commonly called “coupons” are often employed, as they can be readily cleaned and generally fit together well. The statistical problems that occur when using resistance spot welding in high volume environments on actual parts will be discussed subsequently.

Consider the following “thought experiment” performed in a laboratory using coupons per the above in which the weld gun is closed, applying force to the two piece stack-up described in FIG. 1. The objective of this thought experiment is to understand the relation between the time over which current is passed through the stack-up and the strength of the resulting resistance spot weld; strength defined as the tensile force applied to the resulting weld required to separate the pieces. After waiting a short period of time commonly called the “squeeze” time to ensure that the force has stabilized and the coupons have been given time to establish good contact at the faying surfaces (nothing is perfectly flat), current is passed through the sheet metal, regulated to a specified target value by the weld timer. Assume further that the regulated current is sufficient to cause fusion between the metal sheets to be welded if allowed to pass indefinitely

Begin the thought experiment by closing the weld gun, creating axial force on the coupons representing the stack-up to be joined (i.e., sheets A and B). If the weld gun is subsequently opened with no current is passed through the stack-up (corresponding to the regulated current being passed through the stack-up for “zero” time), the stack-up falls apart—there is nothing to create fusion between them, as no current has passed.

Similarly, if the experiment is repeated with current applied to the stack-up for a period such that the temperature at the faying surfaces 103 rises but does not reach the fusion temperature of the metal when the current is removed and the gun subsequently opens, the stack-up again falls apart as no fusion has taken place.

One can continue this train of thought, applying the regulated current for a longer period until the temperature of the metal at the faying surfaces 103 reaches the fusion temperature and the metal begins to fuse. Let voltage be removed and current flow stopped at the instant fusion begins and the stack-up is allowed to cool under the force applied by the weld caps 101, 102. When the weld gun is subsequently opened the coupons comprising the stack-up may stick together, but the bond between the sheets A and B will not be very strong because the area over which the parts have fused is very small and the depth of fusion is not very large. If one tries to pull the resulting joint apart using readily available test equipment designed for the task of measuring strength, it comes apart rather easily.

Repeating the experiment using the same current but applying it over a slightly longer period, one finds a joint that requires more normal force to break it and it is said that this joint has a higher strength than the previous joint. One can repeat the experiment applying the current for a slightly longer period and achieve a joint possessing even higher strength.

Continuing the experiment and increasing the interval over which current is applied, one is tempted to expect a stronger and stronger joint. But a second phenomenon comes into play that limits the possible strength of the joint and actually causes the strength to decrease. As this thought experiment is continued, the metal at the faying surface 103 of the stack-up is melting over an ever-wider area, but the remaining region of un-fused metal between the developing weld nugget 201 and the weld tips becomes thinner as a result and simultaneously hot enough to anneal. As this happens, the force of the weld tips 101, 102 combined with the annealed steel between them causes the weld tips 101, 102 to move toward each other, pushing molten metal out of the way at the faying surfaces 103 in the process and leaving an indentation at the surfaces of the steel which is quite visible in a production weld. Fusion still occurs, but the joint becomes thinner between the weld caps 101, 102 and will begin to tear around the edges of the weld nugget 201 comprising the center of the region of fusion. If this process is allowed to continue, the joint will have ever decreasing strength simply because the joint becomes thin. Eventually, the weld caps 101, 102 may push the metal completely out of the way, leaving a hole in the two pieces and establishing direct contact between the weld caps 101, 102. The joint becomes very weak at this point, and may again be easy to break apart. Even if the joint remains “strong enough” due to a large fusing area surrounding the hole, the hole is generally undesirable and a joint with consistent strength is difficult to attain under this condition.

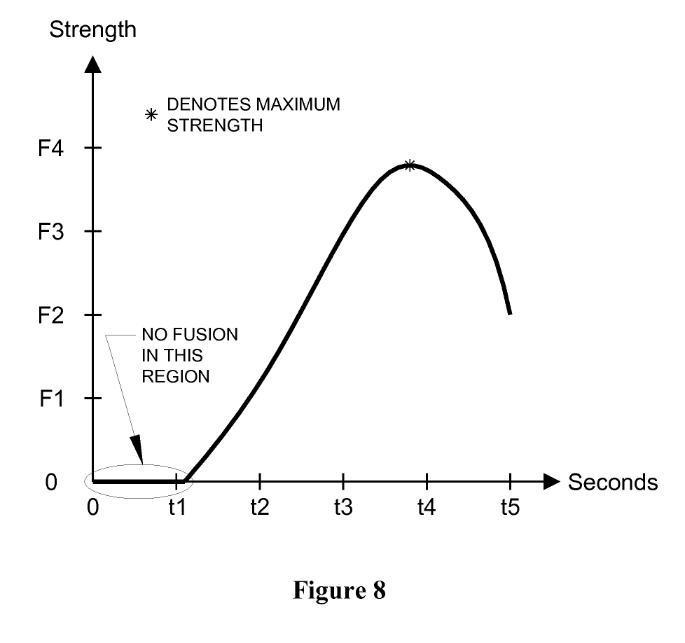

The result of the above thought process is summarized by way of example in FIG. 8 in the form of a plot of strength vs. weld time, from which one can see that for a given joint with fixed weld current and fixed gun pressure applied, there is an optimal weld time at which the strength of the joint is maximized. If current is passed for too little time, the strength of the resulting joint will be less than optimum due to a small fusion region (small weld nugget), and if current is passed for too long, the joint will be weak because the thickness of the joint is reduced.

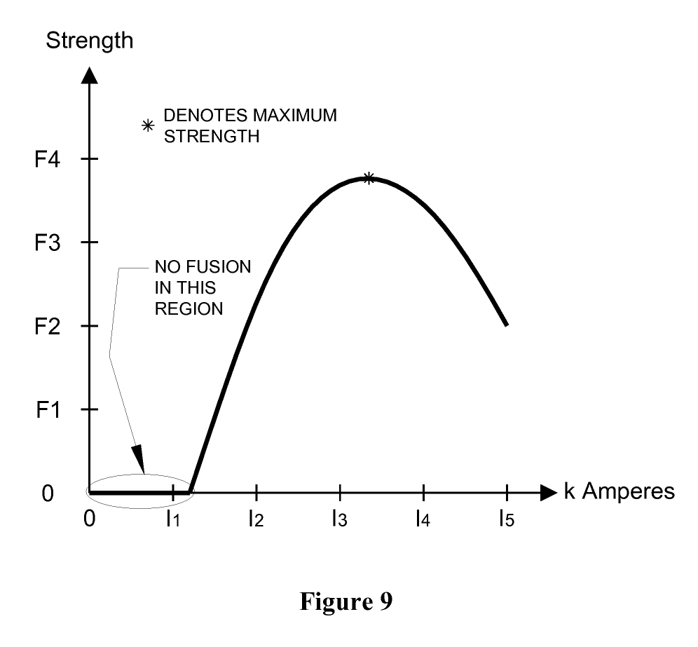

One can repeat the experiment, fixing weld time and varying weld current with an example of the expected result graphically depicted in FIG. 9. Not surprisingly, for a fixed weld time, there is an optimum regulated weld current and force to achieve maximum strength in a particular stack-up. Less current will result in a weaker than optimum weld because the nugget is smaller than optimal, and greater current than this will reduce the strength of the joint because of the “thinning” effect described above. The weld having the maximum strength is, of course, the most desirable weld to make.

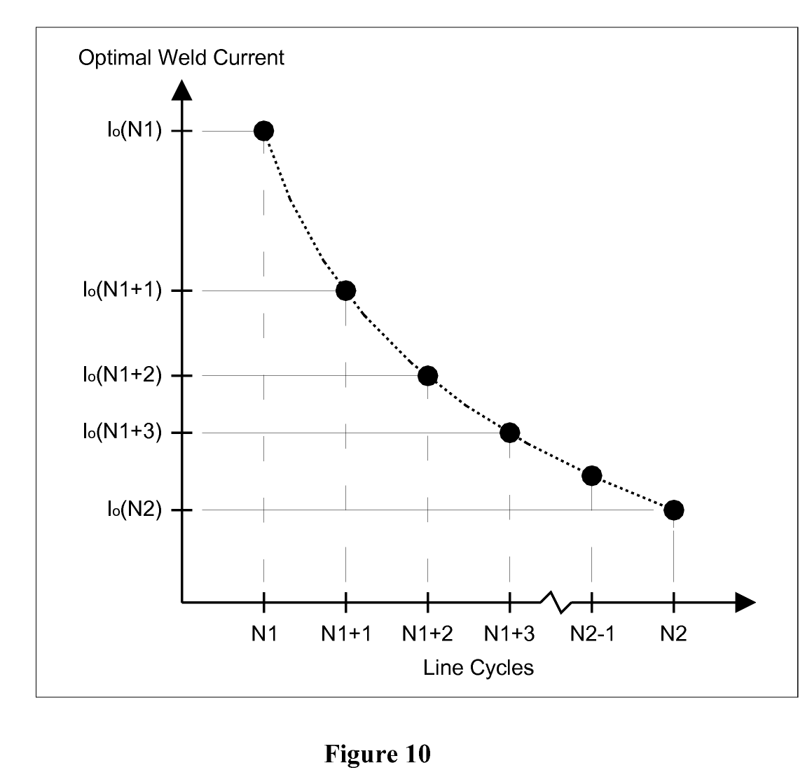

It should be clear from the above discussion that for any given situation, one can develop an experimental relation between weld time and the weld current and force required to achieve a weld of optimal strength for this weld time. A theoretical example of such a relation between weld current and weld time is shown in FIG. 10, assuming a fixed force for simplicity. The significance and potential use of such a curve will become evident from the disclosure below.

Conventionally, one does not design to require the optimal strength available from the weld stack-up in a high volume environment such as construction of an automobile body, as the process is not robust enough for this to be practical. Rather, one designs such that the required strength of a weld is significantly less than the maximum available. Once an optimal heat profile is determined, one can experimentally explore the neighborhood comprising current, time and force around the optimal heat profile to determine the locus of values for which the strength of the resulting joint is acceptable as defined by the actual design requirements for weld strength. This locus of parametric values is commonly called the “weld lobe” in the industry, and it is often obtained directly without first locating the optimum heat profile. Once the weld lobe is established, an initial operating point for the actual weld to be used in manufacture is generally selected somewhere near the mathematical centroid of the weld lobe.

### Dynamic Resistance Curve

The above thought experiment assumes perfect part fit-up and surface preparation, meaning that there are no significant coatings on the metal to be joined, that the force of the weld caps on the metal pieces is sufficient to achieve “perfect” contact between the weld caps and the metal, as well as perfect contact of the metal at the faying surfaces at the end of the squeeze time. Consider now, the more realistic scenario in which the parts to be joined are not flat sheets, having been previously formed into complex shapes by pressing operations, do not fit together perfectly as a result, and for which the surface preparation may not be perfect initially, due to the presence of oxidation, surface contaminants such as die oil and applied metal coatings including non-conductive organic coatings. This scenario is the norm rather than the exception in a high volume automobile body shop.

The resistance between the weld caps 101, 102 during a resistance weld can be estimated by measuring the voltage between the weld caps 101, 102 and the current flowing through the weld caps 101, 102 and applying Ohm's law. In what follows, the dynamic resistance is defined as the resistance measured between the weld caps 101, 102 per above and it is called the dynamic resistance because it changes as the weld progresses. To make a measurement of dynamic resistance, one could make a Kelvin connection to each weld cap 101, 102 and measure the voltage between the weld caps 101, 102, and use a current sensing device to estimate the current flowing through the weld caps 101, 102. Such a measurement method, while practical in a laboratory setting, is generally not practical in an environment such as an automobile body shop where the proximity of low current electrical connections near the welding points readily leads to damage of the connections, rendering a system that depends upon these unreliable.

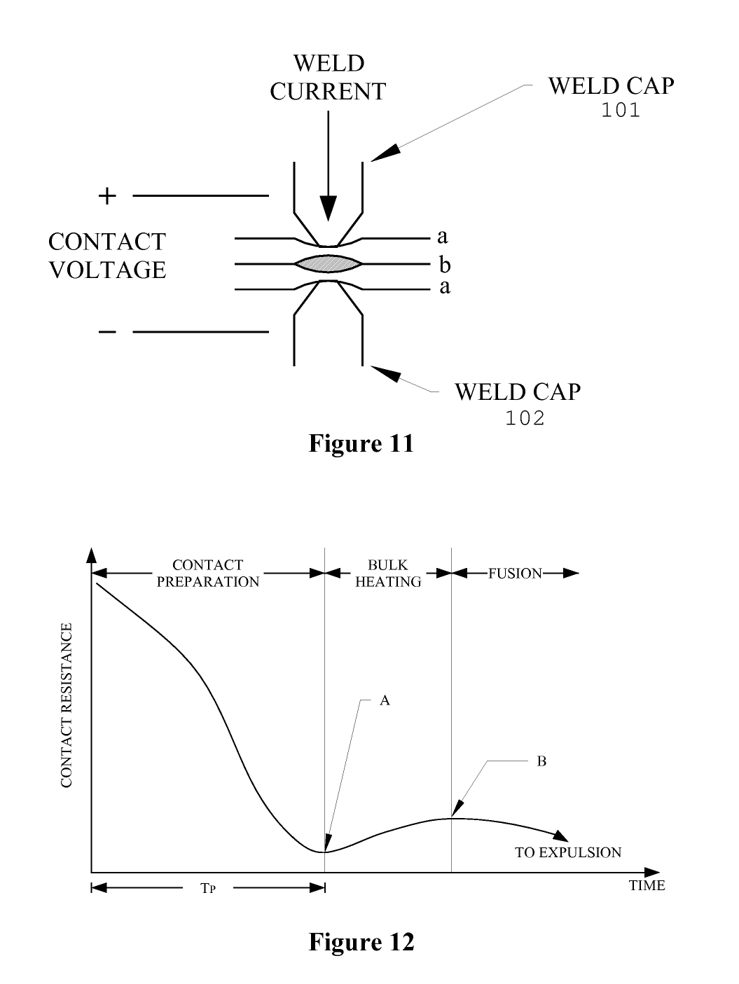

FIG. 11 shows an expanded view of the region around the weld caps 101, 102. The dynamic resistance measured across the weld caps 101, 102 can be modeled as the series connection of the following resistive elements:
The weld cap contact resistance, which is the resistance between a weld cap 101, 102 and the metal surface with which the weld cap 101, 102 physically makes contact. There are two such resistive elements in FIG. 11, each labeled “a”.
The bulk resistance of the metal being joined. Assuming a single piece of metal is placed between the weld caps 101, 102, and that the weld cap and weld cap contact resistance are both negligible, the resistance measured will be due to the resistance of the metal itself. This resistance is generally assumed to be much larger than the weld cap bulk resistance, and this is generally a valid assumption.
The faying surface resistance, defined as the contact resistance of the surfaces of the metal parts being joined.

The bulk resistance of the weld caps 101, 102 themselves is ignored in this model, as it is assumed low enough in comparison with the other resistive elements above to have negligible effect on the dynamic resistance.

FIG. 12 shows how the instantaneous resistance of the load including the weld stack-up varies as a function of time as energy is applied to the metal to make a resistance spot weld. The curve is traditionally broken into three individual regions henceforth referred to as “phases”. The initial phase, when voltage is first applied to the weld, is henceforth referred to as the “contact preparation” phase. Initially, the total weld resistance is usually quite high relative to the final total weld resistance and is unpredictable, as it is highly dependent upon the initial weld cap contact resistance and faying surface resistance. This resistance decreases monotonically for a period as surface contaminants are removed due to the heat applied and the metal anneals, causing the surfaces under pressure to conform to each other, reaching a minimum approximately when complete contact has been made between the weld tips and the metal, and the faying surfaces. Even when complete contact has been made, the faying surface resistance is at this point higher than the bulk resistance of the metal itself and the cap contact resistance. Once full contact has been achieved, most of the heat is generated at the faying surfaces, which in turn develops the highest internal temperatures exactly where they are needed to fuse the two sheets.

Most metals to be joined using the resistance spot weld process have a positive temperature coefficient of resistance. For fixed geometric shape, the instantaneous resistance of the metal increases with temperature. Steel used in automobile and other high volume environments certainly exhibits this characteristic. Referring again to FIG. 12, once the surface impurities have been displaced and the metal has been annealed sufficiently that good contact is attained between all surfaces, but before significant melting of the metal has begun, the observed weld resistance begins to increase due to this characteristic of the metal. This region is referred to as the “bulk heating” region in FIG. 12, and begins at the point where the instantaneous resistance reaches a minimum, labeled “A” in FIG. 12.

Eventually, the temperature of the metal to be welded reaches the point where the metal begins to melt. This happens first at the faying surfaces of the weld, where the contact resistance is still the highest and most of the heat is generated, but also some minor melting may occur at the interface between the weld caps and the metal. Because the weld caps are under considerable pressure in a resistance weld, once melting begins and the metal begins to fuse together, the force applied by the weld caps against the metal begins to drive the tips together through the melting metal as described previously and the metal between the tips becomes thinner as a result. When the rate at which the tips force together exceeds the rate at which the bulk resistance of the metal increases due to temperature, the measured instantaneous resistance again begins to decrease. The point at which the instantaneous resistance is at a maximum is labeled “B” in FIG. 12 and the region to the right of this point is referred to as the “fusion” region, even though fusion has begun slightly earlier in the process. The fusion region represents the time during which the melted region at the faying surface continues to increase in area and depth, but the total thickness of the metal in the neighborhood of the weld caps decreases due to the force exerted by the weld caps. As discussed previously in the treatment of strength, if this process is allowed to continue, eventually the weld caps will move all the metal out of the way and the weld caps will touch. The result will be a so called “blow through” in the metal pieces that were intended to be joined, resulting in a hole in the metal. The optimum weld to achieve a weld of maximum strength discussed above happens some time between the point “A” in FIG. 12 and that point at which the weld caps simply “blow through” the metal.

Of particular interest is the time spent in the contact preparation phase, labeled T_{P} in FIG. 12. While all resistance spot welds spend some time in the contact preparation phase, welds generated using clean, well prepared coupons under laboratory conditions (henceforth ideal surface preparation) actually spend very little time in this preparation phase, and the length of time spent in this phase is repeatable relative to that experienced in a production environment. Once a current profile is determined empirically per the above discussion, applying this current profile to weld coupons in the laboratory, using ideal surface preparation, generates repeatable results. In a production environment, however, the statistical variability in part fit up and surface preparation is significantly wider than experienced in the laboratory and as a result, one usually finds that when the initial optimal parametric values determined in the laboratory are used in the production environment, a significant proportion of the welds do not meet the required strength of the application because the weld specified with a fixed weld current and weld time does not spend enough time in the heating and fusion phases to create a large enough weld nugget. Furthermore, the heat generated in the contact preparation phase is generally much more widely distributed during the contact preparation phase than in the bulk heating and fusion phases. Much of the heat in the contact preparation phase is lost in establishing full contact between the weld caps and the metal and in removing surface contaminants such as die oil, oxidation and even standard coatings such as zinc that provide a high impedance relative to the bulk resistance of the steel. This can be summarized by stating that the mean free path of current is generally higher in the contact preparation phase than in either the bulk heating or fusion phase of the resistance weld, where the path of least resistance passes directly between the weld caps.

Of course, the objective in a production environment is that 100% of the welds meet the design requirements for minimum strength as discussed above. The usual means to achieve this result in production is to increase either the weld current or the weld time (or both) over those values discovered in the laboratory to allow a larger percentage of the welds to create a large enough weld nugget to be deemed “acceptable”. This increase in weld time and/or current is done either with knowledge and forethought or tacitly, but it is done nonetheless.

The potential exists to damage the resistance spot weld if the method of regulating weld current is applied blindly without regard to contact resistance. The tacit assumption in the method of applying regulated current to the weld is that the instantaneous resistance is relatively constant, as it would be in the heating and fusion phases shown in FIG. 12, or at least that the curve shown in FIG. 12 is repeatable. The heat, H, generated by passing a current profile i(t) through a time varying resistance R(t) over an interval T is given by:

$$H = {\int }_{0}^{T} {i}^{2} ( t ) R ( t ) d t \qquad ( 1 )$$

If, for some reason, the contact resistance is higher than it should be, as it would be in the contact preparation phase of FIG. 12, greatly increasing the weld voltage to achieve the weld current prescribed by the constant current weld construct above will generate more heat than intended, resulting in a weld that is thinner than it should be and that can potentially cause a destructive “blow through” as described above.

Also, given the discussion leading to FIG. 12, a reader experienced in feedback control theory will recognize that may be difficult to achieve the prescribed instantaneous weld current in the contact preparation phase of FIG. 12, since the instantaneous resistance is both unpredictable and changing rapidly. Furthermore, the presence of inductance in the circuit comprising the weld control, weld transformer, weld gun and stack-up makes it impossible to achieve or change the weld current instantaneously. This is especially true in a modern digital resistance weld control in which the actual control is achieved by means of a sampled data system in which process corrections are made at fixed intervals of time, generally either at the line voltage frequency in the case of an AC phase controlled resistance welder, or at the inverter switching frequency rate (or less in some commercially available equipment). A modern digital resistance weld control generally incorporates a digital current meter function which estimates the average current passing through the weld. Software in the weld control compares this estimate against the target and generates an exception condition when the resistance weld control could not adequately regulate the weld current. Because it is extremely difficult to regulate weld current during the preparation phase of the weld, most users of the equipment choose to “blank” or ignore the current achieved during an initial period of the weld in making the estimate of average weld current. It is tacitly assumed that during this blanking period, the resistance weld system is doing something predictable, but in general, it is not.

In some embodiments, a % I weld is first prescribed for a short interval to help “guide” the weld process through the contact preparation phase. In Schneider Electric resistance weld controls, for instance, the weld control does not attempt to regulate current in a % I weld, but rather applies the voltage to the weld transformer that is expected to generate the programmed percentage of maximum available current in the heating and fusion phase. One mechanism by which the weld control may determine the voltage to apply, such as in Schneider Electric resistance weld controls, is called “model-based run-to-run control”, and is the topic of the next section.

### Model-Based Run-to-Run Control

For many years, some resistance weld controls have incorporated a method commonly known as model-based run-to-run control that is used to determine the expected characteristics of the load and which can be used as a feed forward element in the control method as well as a means to determine when the load impedance is “normal”. U.S. Pat. No. 6,087,613, incorporated by reference herein as to its entirety, and henceforth referred to as the '613 patent, describes the generation and maintenance of a dynamic model of load impedance that maintains an estimate of the expected load impedance for a resistance weld that is maintained by the weld control. The model is referred to as “dynamic” because the impedance estimated by the model can vary from weld to weld or run to run. However, for a given weld or run, the estimated expected load impedance is only a single value.

A method of maintaining this dynamic load impedance estimate described in the '613 patent uses a technique commonly referred to as “exponentially weighted moving average (EWMA) run-to-run” control, and details of the method abound in the literature. For a simple background discussion of EWMA run-to-run control, the reader is referred to chapter 2 of the text “Run-to-Run Control in Semiconductor Manufacturing”, by Moyne, et al, published by CRC Press under ISBN 0-8493-1178-0. The dynamic run-to-run impedance model incorporated in some resistance weld model-based run-to-run controls, such as those marketed by Schneider Electric, maintains an expected relation between thyristor or inverter conduction time and steady state weld current near the end of a weld, assuming a fixed reference voltage. For example, this reference voltage may be a user programmable parameter indicating the maximum rated voltage of the weld transformer employed. For a fixed reference voltage, the root-mean-square (RMS) weld voltage applied to the load is a monotonically increasing function of conduction time, whether an AC phase control or MFDC control method is used. Even in cases where the weld bus voltage is variable, the method provides a simple means to determine the expected current for the given conduction time and conversely the expected conduction time to achieve a given current. For a desired weld current, if one starts out by simply applying the conduction time predicted by the model to a part with nominal part fit-up, one typically finds that the current rapidly converges to that predicted by the model within a few percent.

One potential advantage of the model-based run-to-run load impedance estimate employed in these resistance weld controls is that the relation established can be used to predict the load impedance (that includes the weld stack-up and possibly also a portion of the weld system), and thus the current that should flow as a function of conduction time for a given line voltage and a given impedance that includes the weld stack-up. Conversely, if the maximum available current at the reference voltage is known, the current corresponding to a percentage of that current can be computed and the corresponding expected thyristor or inverter conduction time determined for the present line voltage. The result is a true linearized % I weld, in which doubling the % I value doubles the weld current applied, and for which the expected current for any given conduction time can be determined.

The load impedance estimated can be based on estimates of voltage and current made from voltage and/or current measurements taken on the primary side of the weld transformer (such as by current measurer 305) or the secondary side of the weld transformer without loss of generality. From many years of experience, making many millions of welds using this method, it is known that under conditions in which the tooling is operating nominally (i.e. without intermittent electrical connections) and the parts to be joined are of nominal fit-up and surface condition, the conduction time applied in this manner should result in a steady state weld current within limits on the order of a few percent of that predicted by the model in normal weld applications without the application of feedback to regulate the weld current, if the run-to-run model is based on a particular resistance spot configuration. Conversely, when current is regulated and the conduction time required to achieve the weld current is compared against the model, it is found that the current predicted by the model for the estimated conduction time typically lies within a few percent of that achieved. Also, the error between the weld current predicted by the run-to-run model for a given conduction time and the actual observed value of weld current from the run-to-run model has been demonstrated to be an excellent predictor of weld quality. In particular, when the weld control determines that the observed conditions do not closely match those predicted by the model, whether or not the weld control met the target current, there is likely something wrong and the weld should be considered suspect. Conversely, when a heat profile has been designed to enable a weld to achieve a certain minimum strength and observed conditions match the model, there is good reason to believe the weld meets the requirement.

In some resistance weld controls (e.g., some Schneider Electric resistance weld controls) employing constant current welding, the required conduction time predicted by the model to achieve the target weld current is used as a feed-forward element as described in the '613 patent, and the relatively tight relation between conduction time and resulting weld current under “normal” conditions is exploited to determine how to apply feedback to regulate the weld current. Specifically, if the weld current observed by the resistance weld control for the present conduction angle is excessively low relative to that predicted by the run-to-run model, it is assumed that there is something wrong with part fit-up or surface preparation and that increasing the voltage (conduction time) to the weld to achieve the target current may be an incorrect action that could result in damage to the weld due to the sharp increase in weld current that would result when proper contact is made. In a system in which proportional-integral control is employed to regulate weld current, it has been determined empirically that a system in which proportional control is enabled when the estimated resistance is twice that predicted by the model (or more concisely when the current achieved by applying the conduction time predicted by the model is greater than 50% of the target), and for which integral control is enabled when the current achieved by a combination of feed-forward and proportional control is within 25% of the target results in a system which provides excellent target current accuracy combined with excellent disturbance rejection. Since the user generally ignores or “blanks” the initial period with respect to current measurement, the user does not normally see the result of this action.

It is observed from FIG. 12 as well as from practical experience that under normal tooling conditions during the contact preparation phase, the instantaneous resistance is monotonically decreasing. When applying the expected weld voltage according to the run-to-run model, once the observed current reaches the threshold as described herein, the remainder of the resistance curve is observed to be quite repeatable from weld to weld, and abnormal conditions can be detected using the teachings of the '613 patent. The implication of this is that the event of the current reaching an appropriate pre-determined threshold based on a single value of expected final weld impedance generated by the run-to-run model can be used as a fairly reliable indicator that uncertainty in the impedance characteristic has effectively ended. Therefore, although the threshold determination as described herein is an estimate and surrogate for the actual formal contact preparation phase end point as indicated by point A in FIG. 12, the formal end point A may be reasonably determined as occurring at the time when the current reaches the appropriate threshold. Thus, the inventors have discovered a method and system by which repeatable welds of statistically higher strength using may be achieved compared to conventional weld controls, and moreover by potentially using statistically less energy than conventional weld controls “tuned” to achieve acceptable weld strength over a large percentage of welds.

This is especially true in high volume applications where an individual weld machine makes the same sequence of weld spots on each part it welds, such as in an automobile body shop where an individual robot makes the same sequence of welds on each automobile body passing through its work space. In these very common cases of high volume manufacturing, a separate run-to-run model may even be maintained by the weld control if desired for each individual welding spot configuration on the vehicle made by the machine.

In what follows, this function of the resistance weld control, which estimates the instantaneous impedance of the weld from the instantaneous weld conditions and compares this estimated instantaneous impedance value against the expected impedance value from the model-based run-to-run estimate of load impedance, is referred to as the load impedance supervisor. This load impedance supervisor function may be performed by, e.g., weld timer 303 and/or by another portion of controller 300.

In a production environment, one cannot predict a-priori when the above threshold current values will be achieved due to the variability of fit-up and surface preparation from weld to weld. As discussed above, if one uses the optimal weld parameters determined empirically in the laboratory on an actual high volume production application, one runs the risk at least of some welds having lower than required strength simply because the required weld current could not be achieved over the interval required to make a good weld due to high initial contact resistance of the sheet metal combined with a long time spent in the contact preparation phase. Accordingly, in conventional weld controls, the user generally must program the weld control with more current or weld time (or both) than is predicted for an optimal weld, to ensure that most, if not all welds will at least have acceptable strength in the face of these fit-up issues. The result is that many, if not most, welds are provided with more heat than required for optimal strength and the best fitting, cleanest components generally receive significantly more heat than is desirable or required, resulting in wasted energy and reduced weld strength.

This is compounded by the present trend in automobile production to employ thinner metals having higher strength to improve the crash worthiness of a vehicle while simultaneously making the automobile body lighter, thereby improving fuel economy. Not surprisingly, these thinner metals are more sensitive to over-heating by the resistance weld process. Perhaps not as intuitively obvious is that the stronger alloys employed by design do not deform as readily and can cause the time spent in the contact preparation phase to increase over a softer, more malleable metal. To simultaneously achieve a lighter, stiffer vehicle, the metal itself needs to be stiffer and thinner. The thinner the metal, the more difficult it is to avoid blow-through, and the stiffer (the less malleable) the metal, the more difficult it is to make proper electrical contact. Simply increasing weld time or weld current is rapidly becoming an unacceptable approach to compensate for variable contact preparation time.

A weld control system that can account for the variability in initial fit-up and surface preparation without needing to overheat many parts to achieve statistically good weld quality is highly desirable. This can be substantially accomplished by modifying either the target weld current or weld time, responsive to the detection of completion of the contact preparation phase of the weld as described above. It is this modification of weld time or weld current that is described herein.

Accordingly, it may be desirable to provide a resistance weld control employing a model-based run-to-run estimate of load impedance, giving the weld control system the ability to maintain and predict the expected impedance of a successfully completed resistance spot weld.

It may further be desirable to provide a load impedance supervisor function that detects when the load impedance observed by the resistance weld control is within a target neighborhood of that impedance predicted by the model-based run-to-run estimate of load impedance.

It may further be desirable to provide a means to specify a target weld current and a range of weld times, the actual weld time employed in making the resistance spot weld responsive to the time required to complete the contact preparation phase.

It may be yet further desirable to provide a means to specify a fixed weld time and a range of target weld currents to make a resistance spot weld, the actual target weld current employed responsive to the time required to complete the contact preparation phase of the weld.

Such a resistance weld control may produce welds of better statistical quality than conventional weld controls while simultaneously reducing the mean energy utilized in the welding process in a high volume production environment such as automotive body assembly.

### Variable Weld Time

As discussed above, it has been observed over many years and many millions of production resistance welds that when a particular resistance weld comprising a specific metal stack-up oriented in a specific geometry utilizing a specific welding tool is completed normally, the final observed impedance of the system for the particular resistance weld is consistent from part to part. In conventional controls employing a run-to-run impedance model, the typical variance in final load impedance is on the order of 3% or less over an estimate comprising a sliding window of many welds. This feature of a production resistance weld, along with the mechanism to compute and maintain the expected weld resistance may be used to advantage. For example, the run-to-run method employed in Schneider Electric weld controls provides the capability to detect when the system has degraded instantaneously (over the course of a few operations) or over the long term. The resistance weld control will normally complete the weld assigned correctly, and in those cases where a weld is not completed normally, provides an indication of nature of the problem in the form of an error message.

If one knows the expected final impedance value of the system in response to the weld, and assumes the tooling has not degraded catastrophically from one weld to another (which can be detected using the run-to-run model), one can estimate when the instantaneous resistance has reduced to a level that the contact preparation phase can be declared to be complete. Various embodiments as described herein utilize the load impedance supervisor function to permit the user to modify the parameters of weld time or weld current to accommodate the variability in preparation time (i.e., the length of the contact preparation phase) seen in high volume resistance spot weld applications. A feature of at least some embodiments is the modification of the load impedance supervisor function to declare the contact preparation phase of the resistance weld complete. To do this, the weld control provides means for the user to program a percentage of target current, and maintains a contact preparation state variable, henceforth denoted CPSV, taking on the enumerated values {NOT_COMPLETE, COMPLETE}, declaring that the load impedance supervisor believes that the contact preparation phase is not complete or has been completed, respectively.

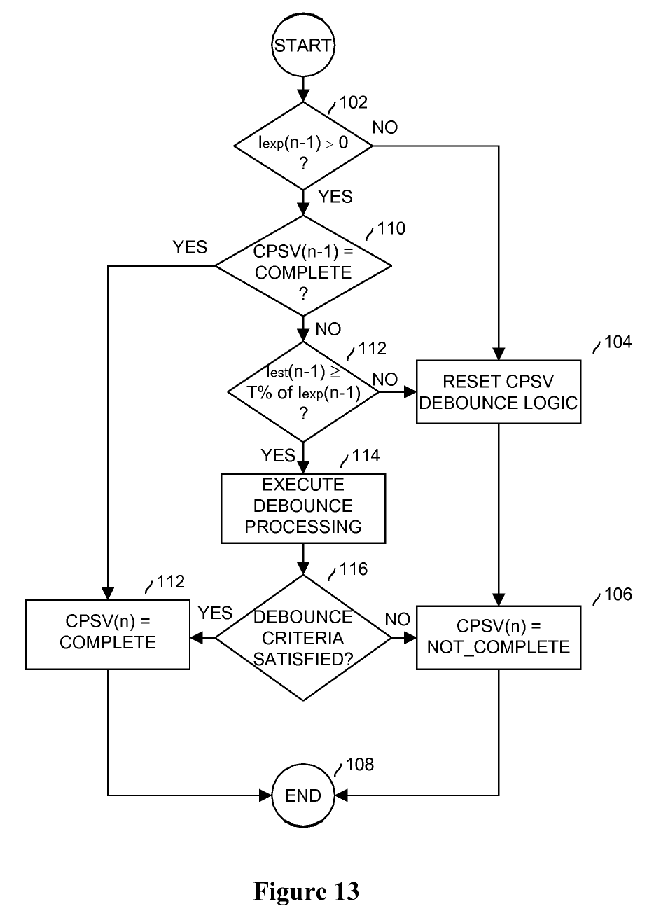

The CPSV variable may be managed by a process such as described in FIG. 13. This process may be executed at the switching frequency of the weld timer, e.g., at line frequency in the case of an AC phase controlled welder (or at a frequency that depends on the line frequency, such as double or half the line frequency) and at the inverter switching frequency (or at a frequency that depends on the inverter switching frequency) in the case of an MFDC welder. In what follows, the term “control cycle” is used to refer to this period, and the index “n” refers to the present control cycle, while the index “n−1” refers to the previous control cycle. Referring to FIG. 13, on entry to the process, the process determines at block 102 whether current was commanded on the previous control cycle by examining an expected target current variable Iₑₓₚ(n−1). Iₑₓₚ may be determined by weld controller 300 as the current expected to be flowing for a given thyristor conduction time in accordance with the run-to-run model previously determined for the particular weld stack-up and used by the load impedance supervisor function of weld controller 300. If current was not commanded on the previous control cycle, Iₑₓₚ(n−1) would be assigned the value “0” by the timer and the outcome of this comparison is “NO”. Under this condition, the process executes process block 104, which resets debounce logic to be discussed subsequently and CPSV(n) is assigned the value NOT_COMPLETE in 106 before the process terminates normally in block 108. If current commanded by the timer in the previous control cycle, Iₑₓₚ(n−1) is assigned a positive, non-zero value by the timer, the outcome of decision block 102 is “YES” and control is directed to decision block 110.

In decision block 110, the value of CPSV from the previous control cycle, CPSV(n−1), is examined. If CSPV(n−1) is assigned the value COMPLETE, then the contact preparation phase has already been declared complete and CPSV(n) is also assigned the value COMPLETE in 112, after which the process terminates normally in 108. If CPSV(n−1) has the value NOT_COMPLETE, the outcome of the decision in 110 is “NO” and control transfers to decision block 112. In decision block 112, the estimated current value from the previous control cycle, Iₑₛₜ(n−1) is compared against the commanded, or driven, value Iₑₓₚ(n−1). Iest is the current actually flowing through the weld stack-up (or an estimate thereof) as determined using, e.g., current measurer 305 in FIG. 3. If the estimated current from the previous control cycle, Iₑₛₜ(n−1), is less than T % of Iₑₓₚ(n−1), where T is a user programmable percentage in one embodiment, the outcome of decision block 112 is “NO”, indicating that the contact preparation phase of the weld is not complete. In this case, control transfers to 104 in which the CPSV debounce logic is reset, CPSV is declared NOT_COMPLETE in 106 and the process terminates normally in 108.

If, in decision block 112, the estimated current from the previous control cycle is greater than or equal to T % of the expected value Iₑₓₚ(n−1), the outcome of decision block 112 is “YES”, indicating that the weld may be exiting the contact preparation phase. Control in this case passes to process block 114, in which debounce processing is executed. Debounce logic is commonly employed in control systems to determine if a presently detected condition is valid or represents a condition of spurious noise. The logic criteria used to declare the contact preparation phase complete may be satisfaction of the condition of block 112 for a number of consecutive control cycles, and process block 114 is simply a counter, indicating the number of times the process has passed through this processing block. In this implementation, process block 104 simply resets the counter used by block 114.

Upon execution of the debounce logic process block 114, control passes to decision block 116 in which satisfaction of the debounce criteria is examined. The debounce logic may be considered satisfied if, for instance, the estimated current is greater than T % of the expected current for two or more consecutive control cycles. More generally, if in block 116 it is determined that not all debounce criteria are satisfied, the outcome of block 116 is “NO”, control passes to block 106 in which CPSV(n) is declared NOT_COMPLETE and the process terminates normally in block 108. If in block 116 all debounce criteria are determined to be satisfied, the outcome of block 116 is “YES”, control passes to block 112 and CPSV(n) is declared COMPLETE and the process terminates normally in block 108.

It can readily be seen that in the example of FIG. 13, once CPSV(n) has been declared “COMPLETE”, it remains complete until a control cycle is detected in which current is not commanded. Of course, expected and estimated currents Iₑₓₚ and Iₑₛₜ may be replaced with expected and estimated weld stack-up total complex impedances Zₑₓₚ and Zₑₛₜ or the resolved expected and estimated weld stack-up resistances (the real portion of the impedances) Rₑₓₚ and Rₑₛₜ in the algorithm of FIG. 13, as desired.

A programming construct may be provided allowing a fixed weld current prescribed over a user defined interval NPmax indicating the maximum time allowed for a weld to be in the contact preparation phase. The format of this new weld programming construct is:

NPmax˜SMART_TIME_CCWELD @ I1 kA

and it is interpreted by the weld control as follows: Weld at a constant current target of I1 kA for an interval not to exceed NPmax cycles. Prematurely terminate this weld instruction if CPSV is detected in the COMPLETE state, generating an exception if the weld construct is completely executed without CPSV detected COMPLETE. This weld is usually followed by a conventional programming structure, such as a CCWELD, comprising the parameters for an optimal weld. The target weld current for this second weld may be I1, or another value chosen to fit the metallurgy requirements as needed.

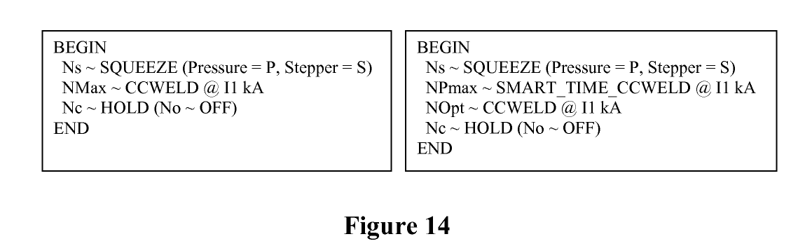

An illustrative weld program incorporating such an instruction to statistically improve the weld strength while simultaneously reducing the energy consumption of the welder producing the weld is shown on the right side of FIG. 14.

To see how this combination of a SMART_TIME_CCWELD instruction compares with a conventional instructions, assume that in a conventional control, a constant current weld of the form:

NMax˜CCWELD @ I1 kA

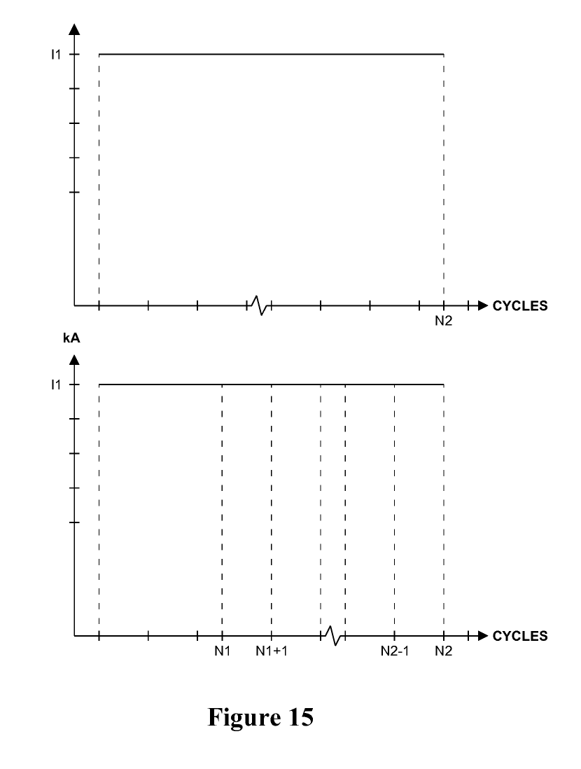

is employed as shown on the left side of FIG. 14 and gives statistically acceptable but not sufficiently excellent results in terms of weld yield and energy consumption per the discussion above. The trajectory generated by this instruction is shown in the upper graph of FIG. 15. If, for the particular stack-up in question, the theoretical optimal weld time for the current I1 kA determined per above is NOpt cycles, then defining NPmax by

NPmax=NMax−NOpt

And programming the following constructs

NPmax˜SMART_TIME_CCWELD @ I1 kA

NOpt˜CCWELD @ I1 kA

as shown on the right side of FIG. 14 results in the generation of one of a family of weld target profiles shown in the lower graph of FIG. 15 when applied to a random stack-up of the type for which the parameters were specified, with the longest weld time NMax, and the shortest possible weld time NOpt. Clearly, in all but the case of welds requiring the very longest allowable contact preparation time, the resulting weld may be shorter in duration, utilize less heat and generate a more nearly optimal weld than the conventional method.

In one variant of this method, the weld control terminates the weld immediately and issues an exception in the form of a fault at the completion of the SMART_TIME_CCWELD if this construct terminates normally (after NPmax line cycles) and the CPSV is not in the COMPLETE state. In another variant of the above method, the weld control completes the weld in accordance with the two instructions above but generates the exception at the end of the weld. In either variant, such an exception can be detected and used by logic to take corrective action. One means of corrective action already incorporated in some resistance weld controls is the ability to attempt to re-weld the present configuration a programmable number of times prior to issuing a fault requiring corrective action by a human operator or equipment external such as a robot directing the resistance spot welds.

A similar construct can be created that permit the system to operate in the % I mode. For example, the following construct may be used:

NPMax˜SMART_TIME_WELD @ P1% I

which operates in a manner identical to the SMART_TIME_CCWELD, but utilizes the % I method of welding and obtains the expected target current from the model-based run-to-run estimate. It should be clear that the constant current and % I programming structures may be mixed as desired.

### Variable Final Target Weld Current

In a second approach, the concept of the optimum current vs. time curve of FIG. 10 is approximated in practice. In this approach, the total weld time is fixed and the final target weld current value is made responsive to the time remaining in the weld after the contact preparation phase of FIG. 12 is complete. To see conceptually how this approach can be made to improve statistical weld quality while simultaneously reducing energy usage assume in FIG. 10 that the weld time/current pair [N1, I_{O}(N1)] corresponds to the optimum weld condition for a weld of N1 cycles assuming ideal surface preparation, and that the pair [N2, I_{O}(N1)] represents the longest weld that can be applied to a weld with target current I_{O}(N1) without reducing the strength of the weld below the requirement for the application. Recall also that in conventional controls, the user is virtually forced to use the pair [N2, I_{O}(N1)] as the target value in order to maximize the percentage of acceptable welds in a given process.

Now, fix the total weld time at N2 cycles and begin welding normally at the optimal target weld current for N2 cycles, I_{O}(N2) prescribed by FIG. 10. If contact preparation is “perfect”, this will generate an optimal weld. But now suppose that after one control cycle, the system detects that the contact preparation phase is not yet complete. If one simply ignores the heat generated during this first control cycle (recall that one cannot predict a-priori where the heat generated in the contact preparation phase is actually manifested), then from FIG. 10, if there are N2−1 cycles remaining in the weld, the optimal current to apply going forward is now I_{O}(N2−1), a value larger than I_{O}(N2), because the remaining weld time is shorter. Similarly, if the contact preparation phase is not complete after N2−1 cycles and the heat generated ignored, the optimal current going forward for the remaining N2−2 cycles is, from FIG. 10, I_{O}(N2−1). This procedure can be repeated, increasing the current in accordance with the values in FIG. 10 until either 1) the load impedance monitor above declares CPSV COMPLETE, or until only N1 cycles of welding remain, in which case the curve of FIG. 10 provides no further information. In general under the assumptions given and assuming CPSV is declared COMPLETE prior to N1 remaining line cycles, then according to FIG. 10, the current at which CPSV was declared COMPLETE is approximately the theoretical optimal weld current to apply to the remainder of the weld, and a weld control that implements this algorithm should be expected to generate welds with statistically higher strength and use less energy than a conventional control which automatically applies the highest possible target current independent of the actual contact preparation time.

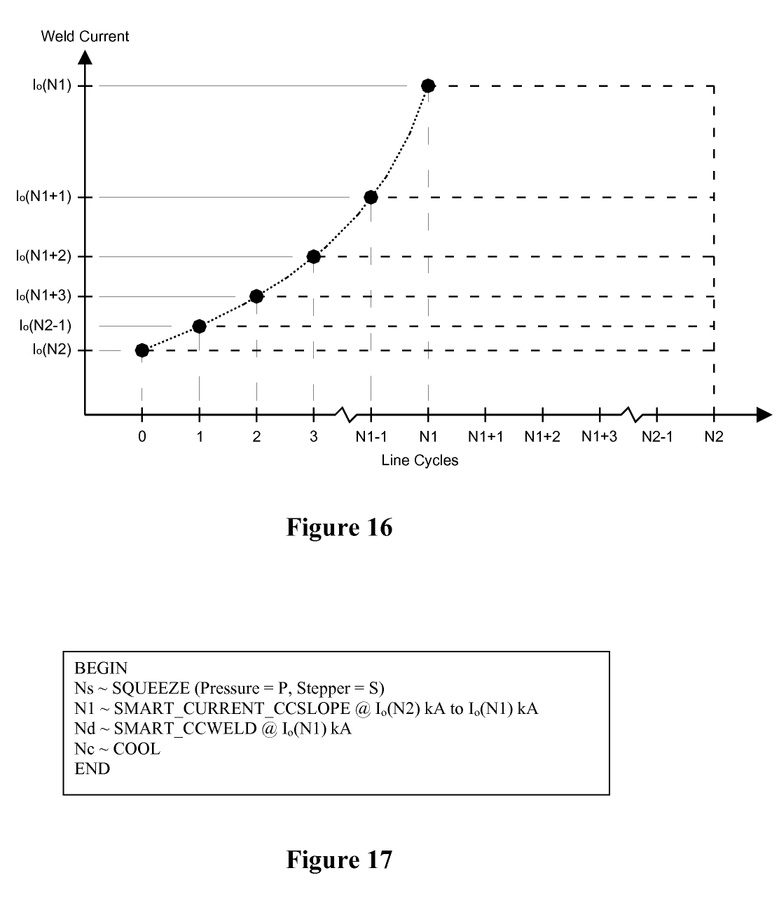

A weld control that employs the algorithm described above would generate one of a family of curves shown in FIG. 16 in response to a random stack-up presented it. If CPSV is not declared COMPLETE prior to N1 remaining line cycles of weld, the weld should simply complete at the maximum value I_{O}(N1) with an exception noted by the weld control, as the weld may not have the desired strength.

In one embodiment of this approach, a SMART_CURRENT_CCSLOPE weld instruction is provided having the same format as the normal CCSLOPE instruction described above:

NN˜SMART_CURRENT_CCSLOPE @ XX kA to YY kA

When the weld control encounters this instruction as part of the weld program, it sets the initial target value to XX kA and during the contact preparation phase of the weld generates a ramp in current, identical in form to the CCSLOPE command described above. While welding using this nominal trajectory, the weld control constantly polls CPSV described above and “freezes” the target current for the remainder of the SMART_CURRENT_CCSLOPE instruction at that value for which the CPSV is first set to the COMPLETE state. This “frozen” value is the value utilized for the remainder of the SMART_CURRENT_CCSLOPE instruction, rather than continuing to ramp.

A second weld construct SMART_CURRENT_CCWELD instruction may also be included in the weld control programming instruction set with a format identical to that of the constant current weld instruction:

MM˜SMART_CCWELD @ XX kA

When this weld construct is encountered in a weld program, the weld control plans to produce MM additional cycles of constant current weld at a nominal target current of XX kA. However, unlike the conventional CCWELD instruction described above, in this case the weld control first checks the status of the contact preparation state managed by the line impedance monitor. If the line impedance monitor has declared the contact preparation state NOT COMPLETE at the initiation of the SMART_CCWELD construct, the weld control utilizes the programmed target value XX kA for the weld and it is executed in a manner identical to the conventional CCWELD instruction. If the line impedance monitor has declared the contact preparation state of the weld COMPLETE at the initiation of the SMART_CCWELD instruction, the weld control ignores the XX kA programmed target value of the SMART_CCWELD instruction and utilizes the final weld trajectory value of the previous weld instruction as the target value, executing MM cycles of constant current weld at this value.

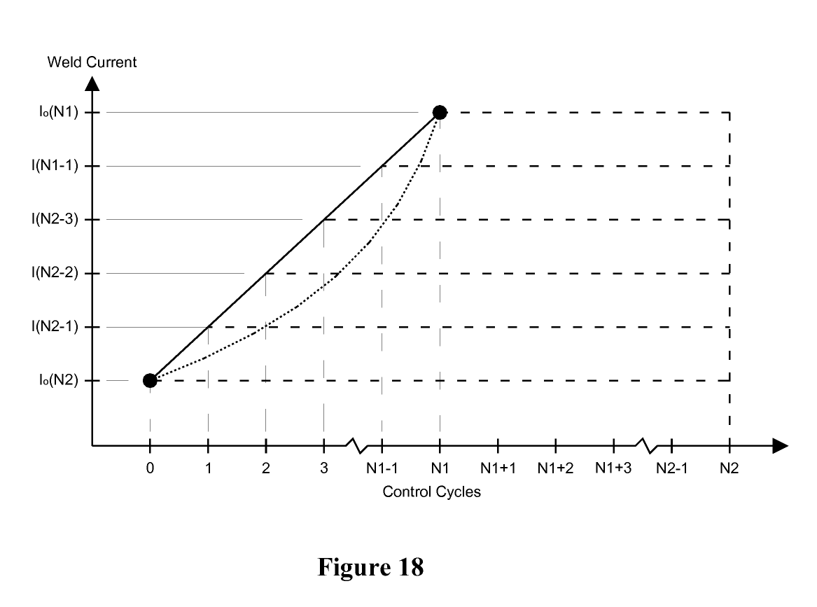

In the embodiment presently under discussion, concatenating the two commands above in a weld program such as shown in FIG. 17 and executing the commands sequentially under the rules described for them results in an individual weld following one of a family of curves shown in FIG. 18.

As can be seen in FIG. 18, the optimal curve of FIG. 10 is approximated by a straight line passing through the points (N1, I_{O}(N1)) and (N2, I_{O}(N2)). In each case, the weld again follows one of a family of trajectories, each of which may result in a more nearly optimal weld employing less energy than the conventional approach utilizing the pair (N2, I_{O}(N1)).

Of course, this implementation is but one of many that could be used, and the specific implementation presented should not be construed as a limitation of the method. For instance, a single weld construct could be defined to generate the family of trajectories shown in FIG. 15 or FIG. 18 rather than assigning the function to two individual weld constructs per method. Nor is the ability to program a weld using programming constructs necessary. Some commercially available resistance weld controls do not provide the capability to program arbitrary weld sequence, substituting a fixed weld sequence in which the user can insert parametric values to define the actual heat profile generated, and one could readily incorporate the features described herein in that format.

1. A method for controlling a resistance weld, comprising:
driving a current through a weld stack-up;
determining whether an end of a contact preparation phase has occurred; and
stopping the driven current at a specific time that is based on when the end of the contact preparation phase is determined to have occurred.

2. The method of claim 1, wherein determining whether the end of the contact preparation phase has occurred comprises:
determining a current flowing through the weld stack-up;
comparing the determined current with a threshold amount of an expected current; and
determining, based on an outcome of the comparing, whether the end of the contact preparation phase has occurred.

3. The method of claim 2, further comprising:
determining a model-based run-to-run estimate of an impedance that includes the weld stack-up; and
determining the expected current from the model-based run-to-run estimate.

4. The method of claim 1, wherein a magnitude of the driven current is fixed.

5. The method of claim 1, further comprising continuing to drive the current through the weld stack-up for a predetermined period of time after the determined end of the contact preparation phase has occurred.

6. A method for controlling a resistance weld, comprising:
driving a current through a weld stack-up, a magnitude of the driven current increasing over time;
determining whether an end of a contact preparation phase has occurred; and
holding the magnitude of the driven current at a fixed level for a time period responsive to determining that the end of the contact preparation phase has occurred.

7. The method of claim 6, wherein driving comprises driving the current such that the magnitude of the driven current increases over time for a period that depends upon when the occurrence of the end of the contact preparation phase is determined.

8. The method of claim 6, wherein determining whether the end of the contact preparation phase has occurred comprises:
determining a current flowing through the weld stack-up;
comparing the determined current with a threshold amount of an expected current; and
determining, based on an outcome of the comparing, whether the end of the contact preparation phase has occurred.

9. The method of claim 8, further comprising:
determining a model-based run-to-run estimate of an impedance that includes the weld stack-up; and
determining the expected current from the model-based run-to-run estimate.

10. An apparatus for controlling a resistance weld of a weld stack-up, the apparatus comprising:
a transformer having first and second windings; and
a weld controller having an output coupled to the first windings and configured to:
drive a current through the first winding,
determine whether an end of a contact preparation phase of the weld stack-up has occurred, and
stop the driven current at a specific time that is based on the determined occurrence of the end of the contact preparation phase.

11. The apparatus of claim 10, wherein the weld controller is configured to determine the end of the contact preparation phase by:
(a) determining a current flowing through the weld stack-up;
(b) determining whether the determined current is within a threshold amount of an expected current; and
(c) determining, based on an outcome of the comparing, whether the end of the contact preparation phase has occurred.

12. The apparatus of claim 11, wherein the weld controller is further configured to determine the expected current from a model-based run-to-run estimate of an impedance that includes the weld stack-up.

13. The apparatus of claim 11, wherein the weld controller is further configured to perform steps (a), (b), and (c) repetitively until it the end of the contact preparation phase is determined to have occurred in step (c).

14. The apparatus of claim 13, wherein the apparatus is configured to receive an alternating current (AC) power source, and the weld controller is configured to repeat steps (a), (b), and (c) at a frequency that depends on the frequency of the AC power source.

15. The apparatus of claim 10, wherein a magnitude of the driven current is fixed.

16. An apparatus for controlling a resistance weld of a weld stack-up, the apparatus comprising:
a transformer having first and second windings; and
a weld controller having an output coupled to the first windings and configured to:
drive a current through the first windings, a magnitude of the driven current increasing over time,
determine whether an end of a contact preparation phase has occurred, and
responsive to determining that the end of the contact preparation phase has occurred, hold the magnitude of the driven current at a fixed level.

17. The apparatus of claim 16, wherein the weld controller is further configured to drive the current such that the magnitude of the driven current increases over time for a period that depends upon when the end of the contact preparation phase is determined to have occurred.

18. The apparatus of claim 16, wherein the weld controller is configured to determine whether the end of the contact preparation phase has occurred by:
determining a current flowing through the weld stack-up;
determining whether the determined current is within a threshold amount of an expected current; and
determining, based on an outcome of the comparing, whether the end of the contact preparation phase has occurred.

19. The apparatus of claim 18, wherein the weld controller is further configured to determine the expected current from a model-based run-to-run estimate of an impedance that includes the weld stack-up.

20. The apparatus of claim 18, wherein the weld controller is further configured to perform steps (a), (b), and (c) repetitively until it is determined in step (c) that the end of the contact preparation phase has occurred.

21. The apparatus of claim 20, wherein the apparatus is configured to receive an alternating current (AC) power source, and the weld controller is configured to repeat steps (a), (b), and (c) at a frequency that depends on the frequency of the AC power source.

22. The apparatus of claim 16, wherein a magnitude of the driven current is fixed.

23. A method for controlling a resistance weld, comprising:
driving a current through a weld stack-up;
determining a current flowing through the weld stack-up;
determining whether the determined current is within a threshold amount of an expected current; and
performing one of the following:
responsive to an outcome of the comparing, stopping the driven current, and
responsive to the outcome of the comparing, holding a magnitude of the driven current at a fixed level.

24. A method for controlling a resistance weld, comprising:
driving a current through a weld stack-up;
determining an impedance of the weld stack-up;
determining whether the determined impedance is within a threshold amount of an expected impedance; and
performing one of the following:
responsive to an outcome of the comparing, stopping the driven current, and
responsive to the outcome of the comparing, holding a magnitude of the driven current at a fixed level.
